(19) United States
(12) Patent Application Publication
(10) Pub. No.: US 2002/0056745 A1
(43) Pub. Date: May 16, 2002

(54) Electronic product identification system for automatic participation and interaction of users on the internet and other electronic or mechanical marketing, diffusion, advertising promotion and/or purchase incentive programs

(76) Inventor: Claudio Oscar De La Fuente, Capital Federal (AR)

Correspondence Address: Andrew W. Chu, Harrison & Egbert, 7th Floor, 412 Main Street, Houston, TX, 77002, US

(21) Appl. No.: 09/885,301

(22) Filed: Jun. 20, 2001

(30) Foreign Application Priority Data
Jun. 20, 2000 (AR) P000103056

(51) Int. Cl. G06F 17/00

(52) U.S. Cl. 235/375; 705/14

(57) ABSTRACT

A universal electronic arrangement for identifying objects and products, for allowing the automatic participation of users in marketing services, that is, commercialization, promotion, purchase incentive, use, or consumption of products. This goal is reached through inserting a micro controller with an antenna into the product itself or it's packaging. These elements may be activated by a radio signal at a predetermined frequency before entering in the distribution channels. In that way, to each specific article or product a unique radio frequency identification is related. Said devices may be of two different types: a) information emission type, or b) information emitting and data storage type.

### BACKGROUND OF THE INVENTION

1. Field of the Invention

The present invention is referred to a new improved marketing system appointed to incentive and motivates users and customers, especially useful as a marketing and commercialization tool. The present invention may be used simultaneously in different products and articles to be promoted interacting electronically with computer equipment connected to Internet or other systems as well as to promotional modules, signs, displays and supermarket gondolas located at sale points, public thoroughfare and the like.

It is referred to an electronic device adaptable in form and size to any kind of elements capable of being part of the product or its packaging and being recognized automatically by computer equipments and similar apparatus. The sole presence of said device is capable of auto executing computer software for required goals, for example, a rewarding program.

Low cost and versatility of the purposed invention allows its use in any kind of commercial products broadening the application scope to different areas.

2. Description of Related Art

Considering that the present invention involves several combined aspects of several areas, background of each of them will be analyzed in detailed below.

Up to now, known marketing and commercialization techniques focused on purchase, use or consumption stimulating or incentive actions with some kind of prizes or rewards (like raffles, exhibitions, etc.) needs a consumer activity involving several necessary elements (for instance, some part of the product's packaging, coupons, mailing, communication means, stands, personnel, etc.). At present, a device allowing the automatic participation of a customer by the sole presence of the element or product itself is not known. Known marketing tools turn difficult to promote the use of some articles like clothes, accessories, merchandising products, etc., and it is not possible to create surprising situations in which the customer does not know how the promoting mechanisms is activated.

In the same sense, marketing campaigns developed in supermarket facilities with determined products usually involve resolving some situation at the cashier, which is bothersome for user and requires sometime changing the billing system.

For marketing actions inside the supermarket facility but out of the cashier's area it is necessary to show the promoted articles or the cashier's ticket to personnel involved in the marketing campaign, for verifying purchase of promoted products and allowing customer participation. This is bothersome for client and makes the marketing activity unreliable.

Advertising elements like exhibition elements (signs, displays, gondolas, etc.) are arranged to attract purchaser's attention. It is not possible to direct a determined message to a specific target. Gondolas with movement mechanisms, sounds and lightning devices are also known, but they are activated by anyone and it is not possible to select this activation by any kind of marketing parameters.

Internet marketing, promoting and advertising systems are not effective since users usually avoid banners. Moreover, it is not possible to create a direct relationship between promoted products and incentive programs, therefore it is not possible to assure the massive use or consumption of promoted products.

Due to the potential possibility of being hacked during a transaction in which a credit card number must be inserted, e-commerce created by Internet creates user's distrust.

The present invention follows the goal of a product or object automatic electronic identification system by inserting during the manufacture or wrapping of said products a microprocessor with an antenna activated by a radio signal corresponding to a unique exclusive serial number for this product or element, and an on-board circuit for PCI bus specially designed for being accessible by any computer equipment (also in peripheric version with RS 232 connection) or computer modules. When promoted elements or products approach said equipment, a signal decoding product identification information is read allowing the auto execution of programmed identification system.

Radio frequency system, so broad regarding its band and use, has been used for access control systems, merchandise traffic tracking systems, and basically in fixed applications for retailing security systems (through external devices adhered to the products) but there are no traces of using said systems as a marketing tool for promoting products, with own identification means for advertising purposes. For that reason, there are no universal systems for obtaining an ordered use of products identifications, recording the assignments and maximizing their commercial use.

At the same time, even when radio frequency explorers used in access control systems, merchandise tracking systems and security systems are well known in the art, the purposed board or card/integrated circuit reading or reading/writing/decoding of the present invention is capable of being installed in any home computer equipment due to the low cost and operative capabilities allowing new functions like networks access control, etc.

With the present invention, traditional promoting systems are improved. A great change in rewarding systems is allowed due to the direct connection created between the product itself (whose purchase, use or consumption is intended to be promoted) and the rewarding system. At sale points, it will be possible to allow an automatic participation of customers in advertising or promoting campaigns without involving personnel, only by bringing the product and approaching it to the detection area. At the same time, signs, lighting devices, sounds and the like may be activated.

With the purposed technology, by the mere presence of a promoted product a corresponding Internet web site may be accessed, or banners may be automatically clicked and programmed functions may be executed related to rewarding programs and the like. Once this kind of technology forms part of individual's computer equipment it will be possible to participate in products promoting campaigns and rewarding systems without sending coupons, packaging, etc. Moreover, regional or international marketing programs and campaigns will also be possible.

For the so-called Web TV system, through which Internet can be accessed through a TV set with a keyboard and a set top box or decoder, promoting campaigns with the viewer participation will be on-line and in real time combining the exhibition of the promoted product and the interaction with the viewer through Internet. With the purposed invention, known-promoting mechanisms will be changed. Sending coupons or tickets, awaiting response or mailing, strategies for retaining the viewer in front of the TV set during the whole TV program, etc., will be no longer necessary. The sole presence of the promoted product near the TV set will be the unique requirement for participating in a rewarding program, obtaining an immediate resolution thereof.

It is possible to establish activities through which the customer could be surprised by activating hired mechanisms in the promoted product ignoring the customer how said mechanisms were activated.

Regarding e-commerce, credit cards including a user identification encrypted therein, may allow safer commercial transactions from the customer's personal computer equipment.

Due to the great number of potential applications and products in which the present invention may be applied, a universal frequency and identification assignment system is created for avoiding interferences or conflicts situations between user's elements.

Some high-tech products including an identification circuit are known in the market, for instance, cellular phones. But this capability was not used yet for allowing the user to participate in marketing campaigns like in the present case through which the system may be activated with the sole presence of the promoted product or article.

### BRIEF SUMMARY OF THE INVENTION

A universal electronic arrangement for identifying objects and products, for allowing the automatic participation of users in marketing services, that is, commercialization, promotion, purchase incentive, use, or consumption of products.

This goal is reached through inserting a micro controller with an antenna into the product itself or it's packaging. These elements may be activated by a radio signal at a predetermined frequency before entering in the distribution channels. In that way, to each specific article or product a unique radio frequency identification is related. Said devices may be of two different types: a) information emission type, or b) information emitting and data storage type.

A basic reading circuit or reading/writing/decoding circuit (two options) on board for PCI bus adaptable to any kind of computer equipment or peripherical devices, with an antenna for attaching it to the PC cabinet, allows recognition of signals emitted by the objects itself, by simply approaching them to the detection area, activating said rewarding systems through the auto execution of software and pertinent mechanisms.

The present invention allows the automatic participation of users and consumers of predetermined products in rewarding programs with immediate resolution, creating a direct connection between the promoted product and the rewarding activity. At the same time, mechanisms and incorporated circuits may be activated in signs, gondolas, displays and different exhibition and advertising products.

This basic electronic arrangement allows its application in different circumstances and environments, creating a new inventive concept.

In the present specification, promotional modules are structures of different size and shape, composed by a reading device, computer equipment, a ticket printer and rewarding system software. Said means may be located at sale points, public thoroughfare, events, etc. When a promoted article is detected, reading device will auto execute rewarding software allowing the automatic participation of the product's customer. The resolution is immediate, and if a prize is obtained, the corresponding certificate is printed, or punctuation may be recorded at the product's micro controller.

The present invention makes possible that a PC (or set to box, or decoder, or Web TV) including a radio frequency reading board allows the interaction of objects or products to be promoted through Internet. Once they are detected, an automatic accessing to web sites and web pages, clicking advertising banners, interlinking web sites, taking part in raffles, etc., is allowed, through communication of IP (Internet Protocol) identifications and other commands. Using the purposed technology, participation of users at home is allowed, assuring that the promoted product is present.

The arrangement of the present invention will maximize marketing and merchandising product functions with a specific direct utility.

### BRIEF DESCRIPTION OF THE SEVERAL VIEWS OF THE DRAWINGS

FIG. 1 schematically shows the present invention illustrating how a broad kind of products and objects provided with unique code identification devices (1) interact (2) with incentive and motivational systems composed by several alternatives (12). The same element may auto execute, in accordance with the designed promotional program, different kind of software, modules or mechanisms, composed by corresponding reading circuit or writing/reading circuit. Due to the universatility of the present invention, different elements create different effects in the same interrogating means.

FIG. 2 schematically shows a basic module capable of being installed at a supermarket facility or any other sale point. Products and elements provided with the Activated Radio frequency Identification Device (1) emit a radio signal (2) with a unique serial number that is received by the RF interrogating device once approaching to the module. Said module may be part of a stand, a cabinet or the product itself, and is composed by a receiving antenna (3) connected to the reading board or reading/writing board and computer decoder (4) which may content in its hard disk a software designed in accordance to the incentive activity to be carried out, or may also be connected to Internet.

Once the signal is received, respective software is auto executed (stored at the hard disk, in a web site or the like) and a video monitor (5) will show the promotional activity as well as the immediate resolution thereof. Moreover, this may be complemented by a sound system (6), for communicating the results of the incentive program using sounds. Finally, a printer (7) will print the corresponding awarding certificates (8).

In accordance with the rewarding program options, the RF activated elements could be valid for participating several times or a single time. In this case, immediately after the execution of the corresponding software, the elements will lost its capabilities, for example due to the action of a module deactivator device (9). For elements using microchip technology with capability of storing information, the module may record punctuation, bonus or any other benefits to said element.

FIG. 3 schematically shows (at the upper part thereof) basic functioning of purposed radio frequency automatic identification system, as well as (at the lower part) some alternatives of devices inserted in articles (1) and an example of a radio frequency reading/decoding device for inserting in mechanical, electronic apparatuses and computer equipment (10) showing its simplicity and low cost.

FIG. 4 shows the invented electronic arrangement, in personal computer equipment connected to Internet (11). Said computer equipment with an RF reading board (4) has a rectangular antenna (3), which may be adhered to the monitor frame, inserted in the pad mouse or separately. While detecting the presence of an activated product by radio frequency, the emitted signal will communicate a unique message (2) auto executing a determined command, possibly generating the automatic entering to a web site, participating in a rewarding program, immediate resolution activity or the like, allowing a direct interaction between web servers and the product whose purchase, use or consumption is intended to be promoted.

FIG. 5 schematically shows the application of the present invention showing how a broad spectrum of radio frequency identified products (1) may interact similarly with different receiving devices, auto executing devices and software designed therefor.

### DETAILED DESCRIPTION OF THE INVENTION

Making reference to the attached drawings, the present invention is referred to a universal electronic arrangement through which products and objects are identified for its automatic use in marketing services for commercial promoting activities, purchasing incentive programs, and the like. Products and objects are identified through incorporating as a part of its packaging or material a micro controller with an antenna. These elements are activated by a radio signal at a predetermined frequency before entering in commercial distribution channels. Thus, each product corresponds to a unique identification by radio frequency. In accordance with the product characteristics and promoting programs designed, said devices may be: a) information emission type, or b) information emission and data storing type. In accordance with shape, size and material used, different kind of micro controllers and antennas may be used.

These products will be recognized through a reading circuit or a reading/writing circuit and basic decoder (two options) PCI on board compatible with any computer equipment or peripheric device also adaptable to mechanical or electronic devices.

Depending on the characteristics to be detected, place where is installed, and physical characteristics, exploring circuits will be arranged in different ways, depending on the exploring area necessary for the incentive action to be taken. In that way, the most notorious difference will be the antenna size, which for instance may be rectangular, allowing its installation in the PC cabinet or may form part of a stand structure.

While entering in the detection area, a signal is emitted by the product communicating a unique identification, recognized by a reading device translating it into activation commands for incentive mechanisms or programs.

The present invention allows the automatic participation of users and consumers of determined products in rewarding programs with immediate resolution, creating a direct connection between the product and the incentive activity created therefrom. Obtaining a prize or reward may involve receiving a printed certificate, punctuation recorded in a mileage program, or in the element itself (with the capability of recording information); etc.

There are thousands of objects, products and elements with the capability of including a micro controller, basically due to its small size (lesser than 0.5 mm of thickness). At the same time, there are multiple applications for the present invention in the marketing and advertising field, from different modules with public access up to a general participation of Internet users using their respective computer equipment.

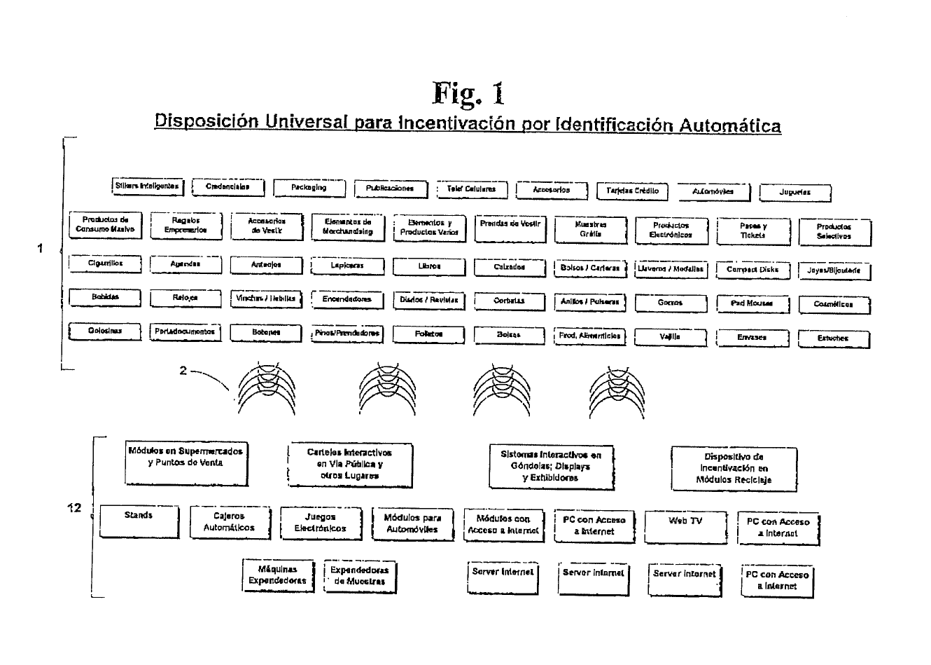

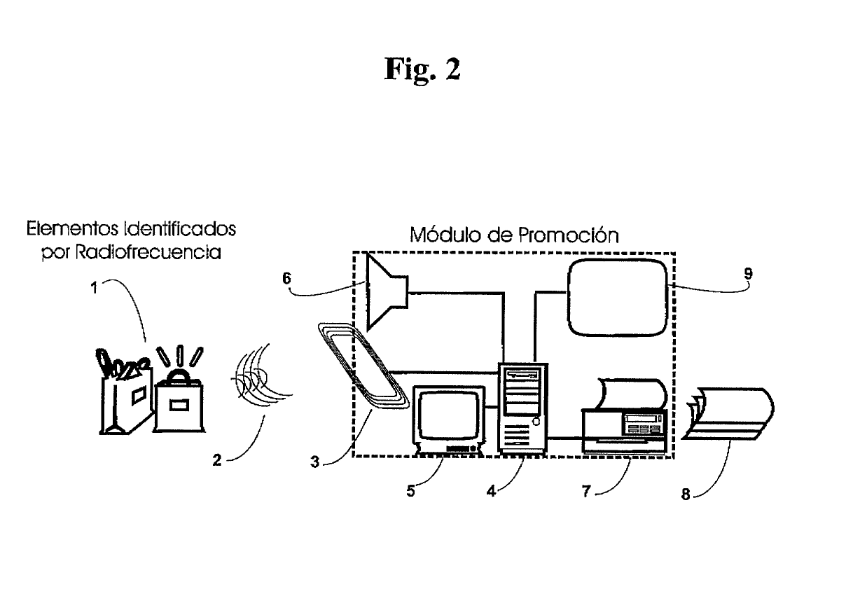

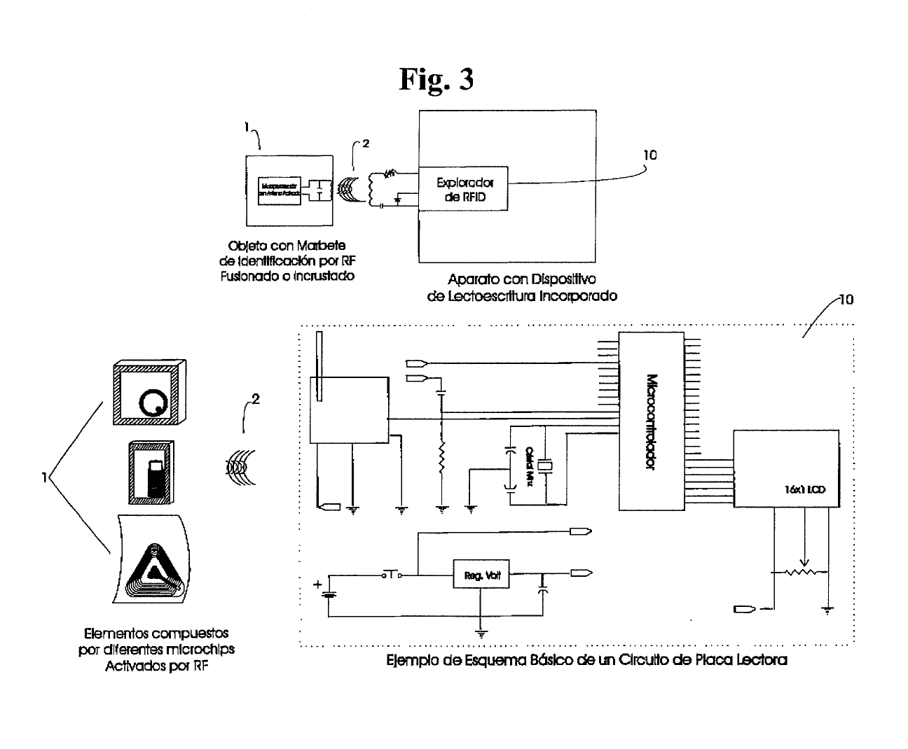

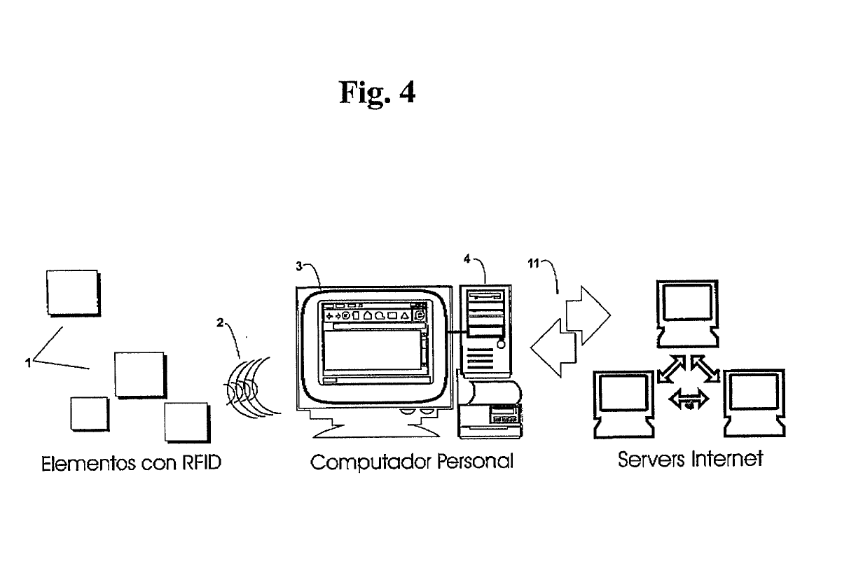

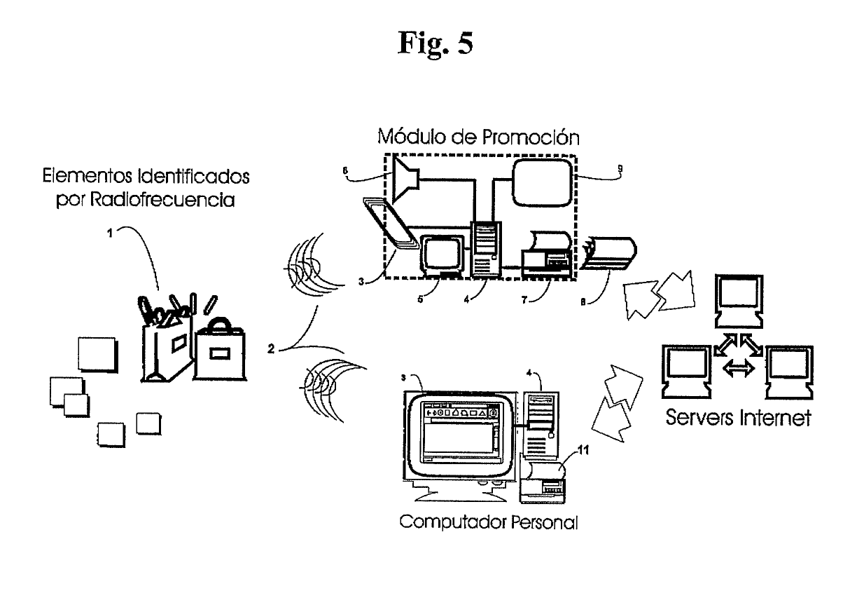

The present invention is related to a universal electronic arrangement so that radio frequency identified objects may interact with a broad spectrum of market devices (FIG. 1) auto executing only mechanisms and programs specifically designed. Thus, it will be necessary to register each frequency assignment and serial number. This task may be in charge of an administration system. Some preferred embodiments of the present invention are described below. These embodiments cannot be understood as a limitation of the scope of protection of the present invention, clearly defined by the appended claims.

a.—Intelligent stickers: advertising stickers are a well-known promotional element. In this case, it will be composed of a simulated identifying device capable of auto executing incentive programs generating a special use motivation. For example, these stickers may by applied to a car, in this case scanning and exploring modules will be located in parking areas, gas stations, etc.

b.—Clothes: most dressing articles may include an RF emitting device, for example inside a button, in embroidery, in a buckle, etc. Incentive programs may be performed through Internet sites, determined places and events for users of this kind of products.

c.—Footwear: as a part of its sole sport shoes may include a reading/writing microprocessor able to record information. A thin foam rug with leds and a printed logo may be a radio frequency antenna connected to a circuit auto executing different programs. A user stand on said rug will enable the user to participate in different awarding programs and mileages programs.

d.—Massive products: this device may be part of any kind of packaging such as cigarettes, bottle's cups, cans, packages, etc.

e.—Merchandising and advertising products: this is an innovative concept due to the incorporation of a micro controller and an antenna during the product's manufacture simulated in its composition. Said micro controller device will be activated representing a determined identification. With the sole presence of the product, users will enable different mechanisms, integrated circuits, etc., or they will auto execute some e-mails, web sites, web banners, etc., or awarding programs installed therein. Thus, the use of this kind of elements will be promoted (for example, pins, watches, mouse pads, buckles, etc.).

f.—Brochures, cards, coupons and other graphical material: descriptive brochures delivered with promotional purposes may extend their messages and instructions by radio frequency identification. Exposing them to detection areas of modules or PCs, will render to enabling programs related to them. Similarly, ruffles coupons will allow an immediate resolution. Cards may also include a unique code that the user must enter as a requirement for participating, also allowing the user registration and future regulation.

g.—Recycling: programs for incentive recycling activities may be developed, for instance, through wrapping paper capable of being recycled. Modules in which one of said wrapping material might be entered automatically entering in a rewarding program may be enabled.

h.—Credit or banking cards: credit cards manufactured with a chip inside may allow to the user to participate in certain incentive activities, doing safe purchasing operations through Internet, etc.

i.—Publications: an interactive system between newspapers, magazines, books and Internet pages may be created using the present invention, identifying them with an activating device. Inserts and advertising pages may also be used with this technology.

j.—Elements with an original automatic identification system: cellular phones provide an original RF identification. The present invention may be useful for telephone manufacturers or telephonic service providers since incentive modules may be installed in said cellular phones. Said modules may be composed of an antenna and a predetermined frequencies reader device, computer equipment including rewarding programs or Internet access to the product's web page. Telephone users, once enter in the incentive zone, will automatically participate in rewarding programs through a previous standard communication.

k.—Credential cards: this kind of elements delivered in fairs, exhibitions and the like may include a reading or reading/writing microchip with an antenna for participating in promoting campaigns in stands or access areas with exploring modules connected to promoting systems.

Moreover, the present invention may be applied for addressing specific commercial messages to a predetermined targeted public. For example:

a.—Promotion modules: a reading device, computer equipment, a ticket printer and incentive software may compose said modules. These modules may be located at sale points, and when a promoted article is detected said reading device will auto execute a rewarding program allowing the automatic participation of the user. Resolution is immediate and if the user wins a prize the corresponding certificate may be printed.

b.—Modules for receiving cards, coupons, etc.: said modules may include a reading device for auto executing mechanisms or programs once a card or coupon is inserted for participating in samples delivering, raffles, etc.

c.—Interactive systems for static advertising systems and exhibition modules: the present invention may be applied to electromechanical devices for signs, gondolas, stands, displays and exhibitors so that when a promoted element is detected, a mechanisms or a circuit is automatically activated.

d.—Vending machines for samples, coupons, tickets, bonus, etc.: as in the former case, delivering of samples, tickets, and bonus may be activated with the purposed technology.

e.—Internet access modules: stands for promoting internet access or determined web sites may be provided with a reading device allowing the auto execution of different commands once a promoted product is detected, creating an automatic access to internet, raffles, etc.

I claim:

1. ELECTRONIC PRODUCT IDENTIFICATION SYSTEM FOR AUTOMATIC PARTICIPATION AND INTERACTION ON THE INTERNET AND OTHER ELECTRONIC OR MECHANICAL MARKETING, DIFFUSION, ADVERTISING, PROMOTION OR PURCHASE INCENTIVE SYSTEMS, characterized by embedding a microprocessor with an antenna in a product package or material capable of being activated through a radio signal before entering in commercial distribution channels, and interact with reading/writing devices located at modules or computer equipment capable of detecting a promoted product including said microprocessor and executing a rewarding program.

2. ELECTRONIC PRODUCT IDENTIFICATION SYSTEM, in accordance to claim 1, wherein the serial identification system created between said micro processor and the product creates a direct relationship between products to be promoted and rewarding programs, allowing the automatic participation of users in incentive programs.

3. ELECTRONIC PRODUCT IDENTIFICATION SYSTEM, in accordance to claim 1, wherein each product is identified with a unique identification code.

4. ELECTRONIC PRODUCT IDENTIFICATION SYSTEM, in accordance to claim 1, wherein the purpose system creates an ordered and recorded registration of each product involved in the rewarding program.

5. ELECTRONIC PRODUCT IDENTIFICATION SYSTEM, in accordance to claim 1, wherein this system may be applied to: footwear, clothes, accessories, packages, merchandising products, printed material, cards, stickers, toys, publications, credit cards, samples addressed to be used in marketing fields and promotional activities.

6. ELECTRONIC PRODUCT IDENTIFICATION SYSTEM, in accordance to claim 1, wherein apparatuses and physical structures composed by a radio frequency exploring board of identified products are involved appointed to executing mechanisms, electronic circuits, computer software and Internet.
